(19) United States
(12) Patent Application Publication
(10) Pub. No.: US 2008/0128311 A1
(43) Pub. Date: Jun. 5, 2008

(54) Soft flexible personal pill carrier

(76) Inventor: Ramsey A. Ford, Cincinnati, OH (US)

Correspondence Address: William M. Selenke, 5 Drummond St., Cincinnati, OH, 45218, US

(21) Appl. No.: 11/804,192

(22) Filed: May 17, 2007

Related U.S. Application Data
(60) Provisional application No. 60/809,621, filed on May 31, 2006.

(51) Int. Cl. A61J 1/03; B65D 30/22

(52) U.S. Cl. 206/534; 383/37

(57) ABSTRACT

The invention is a soft flexible personal pill carrier with a larger soft flexible bag that is closed with a zipper or Velcro™. The larger bag contains one or more smaller soft flexible bags. The smaller soft flexible bags further have two or more sub chambers. Each sub chamber is also closed by zipper or Velcro™ and contain the aliquot of pills. The smaller soft flexible bags are placed and transported within the larger flexible bag. The smaller soft flexible bags may be folded as a wallet or further folded in an accordion fold.

### FIELD OF INVENTION

The present invention is concerned with various kinds of devices and carriers for capsules or tablets (pills). Such carriers have small holes or cavities with coverings or lids on the holes or cavities. These carriers have various markings which indicate the time that the particular medications are to be taken by the patient. Most commercial and patent art teaches the use of rigid material such as plastic for the pill carriers. The present invention is concerned with such devices made out of soft and flexible materials.

### BACKGROUND OF INVENTION

Many Americans, especially older Americans, have prescribed pharmaceuticals that they must take on prescribed schedule. For this purpose, both the commercial art and the patent art have a number of types of containers to regulate the schedule of ingesting pills. A typical carrier has seven individual small compartments labeled Sunday through Saturday. Depending on the number and types of medications the individual person may have two or more of these standard carriers. In other cases a container may store a month's supply of medication.

Of course, if the person taking the medications is at his home there are no particular problems. If the person is shopping or traveling for any extended period of time the pillboxes must be carried with the patient. Carrying the standard plastic easy open pillboxes with a person can produce some disadvantages. The medications can rattle and create embarrassing noises and tells the world that you are taking medications. In other cases the medication can be shaken and broken into smaller pieces. The rigid plastic containers can be somewhat uncomfortable to carry. Finally, the plastic lids of the current art can accidentally open and cause undesired spillage of the pills.

For these reasons it is advantageous to have a soft and flexible system to arrange and store various medications. Soft and flexible containers should prevent breakage, noise, and feel soft to the person carrying the medication. Likewise, the present invention prevents unwarranted and undesired spillage which can readily occur when the plastic lids of the current art accidentally open.

### SUMMERY OF INVENTION

The invention is soft flexible personal pill carrier comprising larger soft flexible bag with a closing means such as a zipper or Velcro™ inclosing one or more smaller soft flexible bags. The smaller soft flexible bags further have two or more sub chambers. Each sub chamber can be closed by a zipper or Velcro™ and can receive the needed aliquot of pills. The smaller soft flexible bags can be joined in series of two or more placed and transported within the larger flexible bag. The smaller soft flexible bags which may have printed indices may also be folded as a wallet or further folded in an accordion fold.

### DETAILED DESCRIPTION OF FIGURES

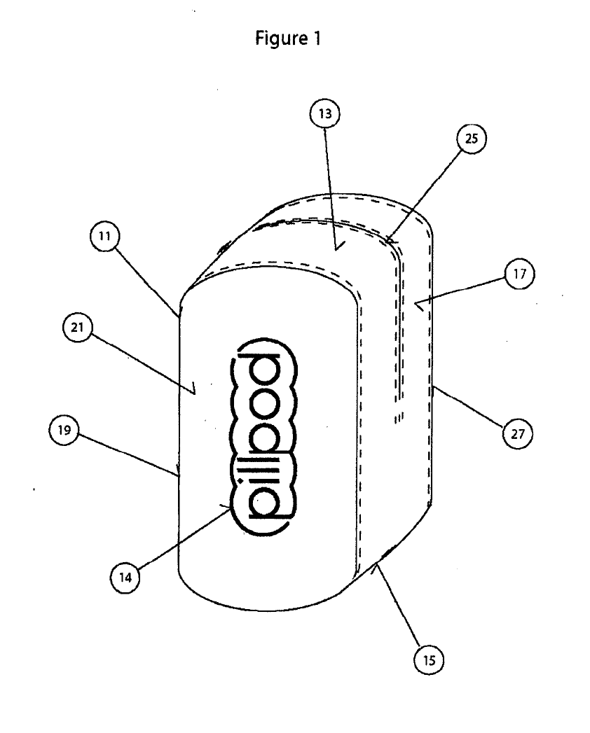

FIG. 1 shows the outer container 11 of soft flexible personal pill carrier. Outer container 11 is generally rectangular box shaped. The inventor chooses to call his product “Pill Pod” 14. Container 11 is a larger soft flexible bag with a closing means 25 such as Velcro™ or a zipper. Larger soft flexible bag 11 has a top panel 13, a bottom panel 15, front panel 21, back panel 27, and side panels 17 and 19.

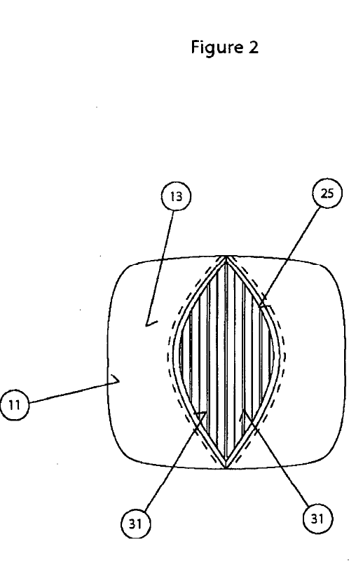

FIG. 2 shows top panel 13 of container 11 of soft flexible personal pill carrier. Closing means 25 is open showing one or more smaller soft flexible bags 31.

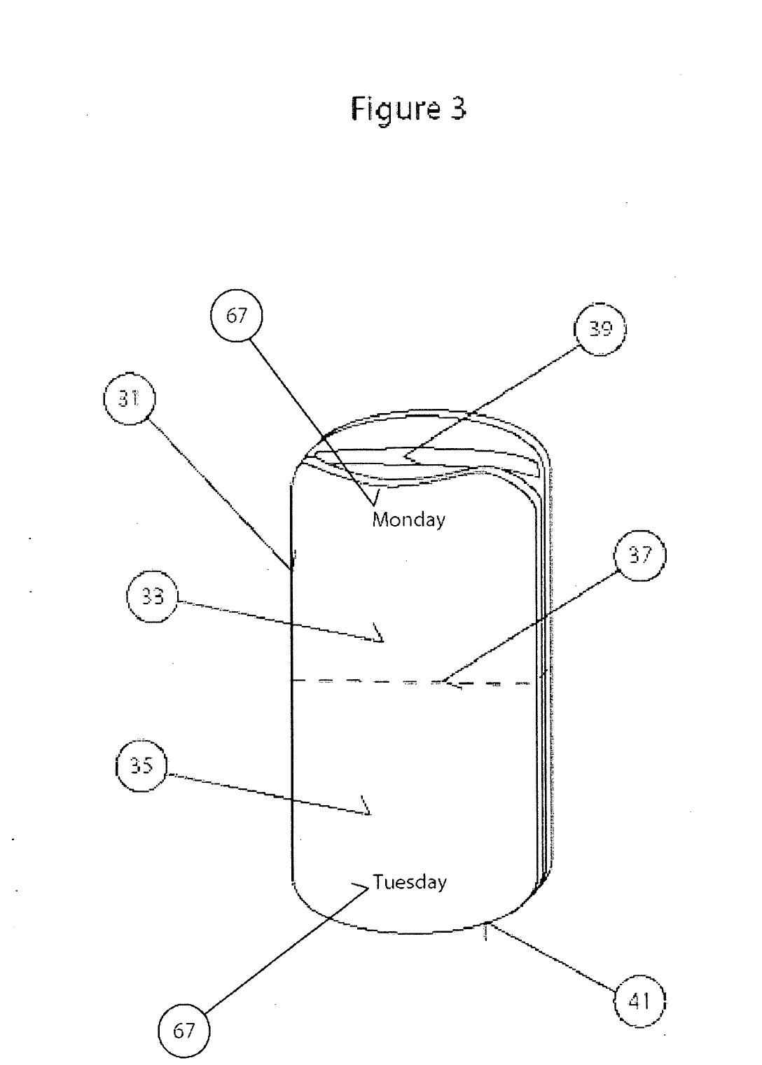

FIG. 3 shows smaller soft flexible bag 31 Smaller flexible bag 31 has upper sub chamber 33 and lower sub chamber 35 caused by a dividing means 37 such as sewing. Sub chambers 33 and 35 each has a second closing means 39 and 41 such as Velcro™ or zippers. Upper sub chamber 33 has an indices 67 indicated by “Monday;” lower chamber 35 has a second indices 67 indicated by “Tuesday.” The various indices indicate the contents of the sub chambers.

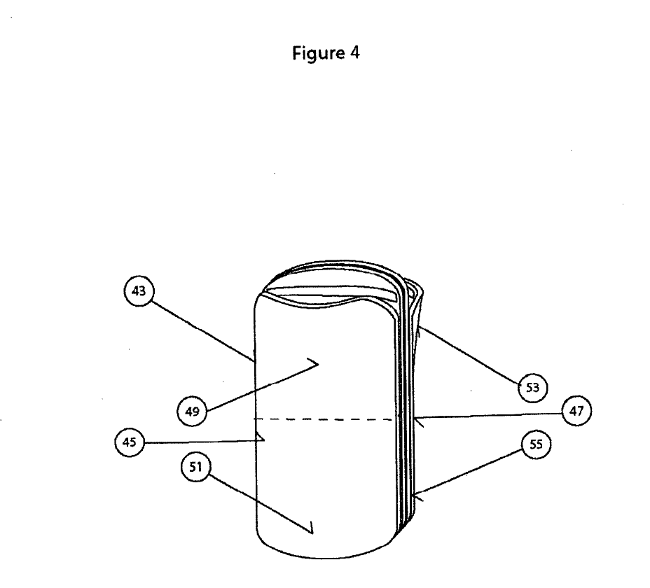

FIG. 4 shows smaller flexible bag 43 as a wallet with 4 chambers. On front 45 is second upper chamber 49 and second lower chamber 51. Back 47 has third upper chamber 53 third lower chamber 55.

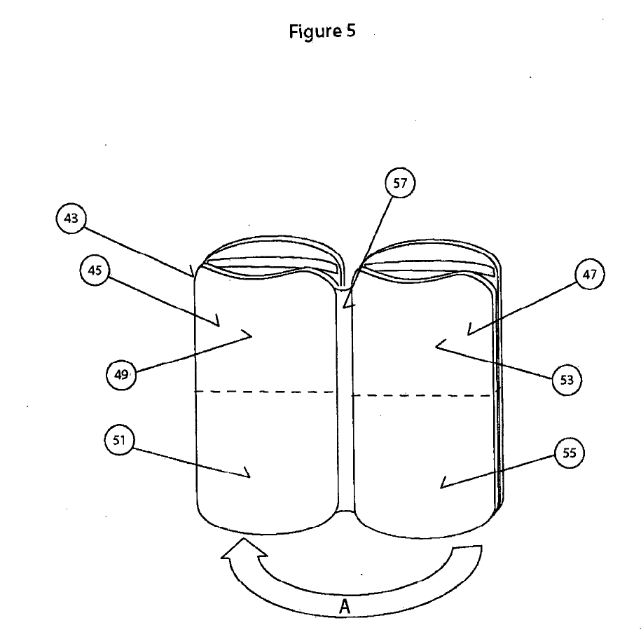

FIG. 5 shows a pair of smaller flexible bags 53 with sub chambers 56 and 57 shown as an opened wallet construct 50. Arrow A indicates the direction of opening for smaller flexible bags. Living hinges 57 connects smaller flexible bags 53.

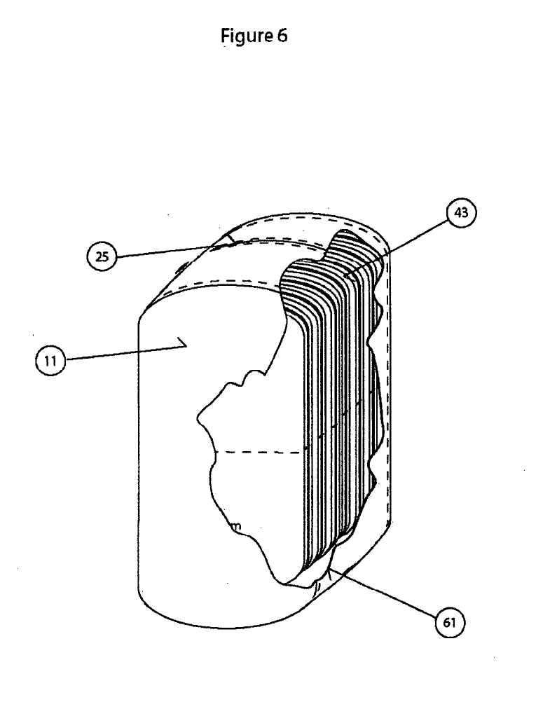

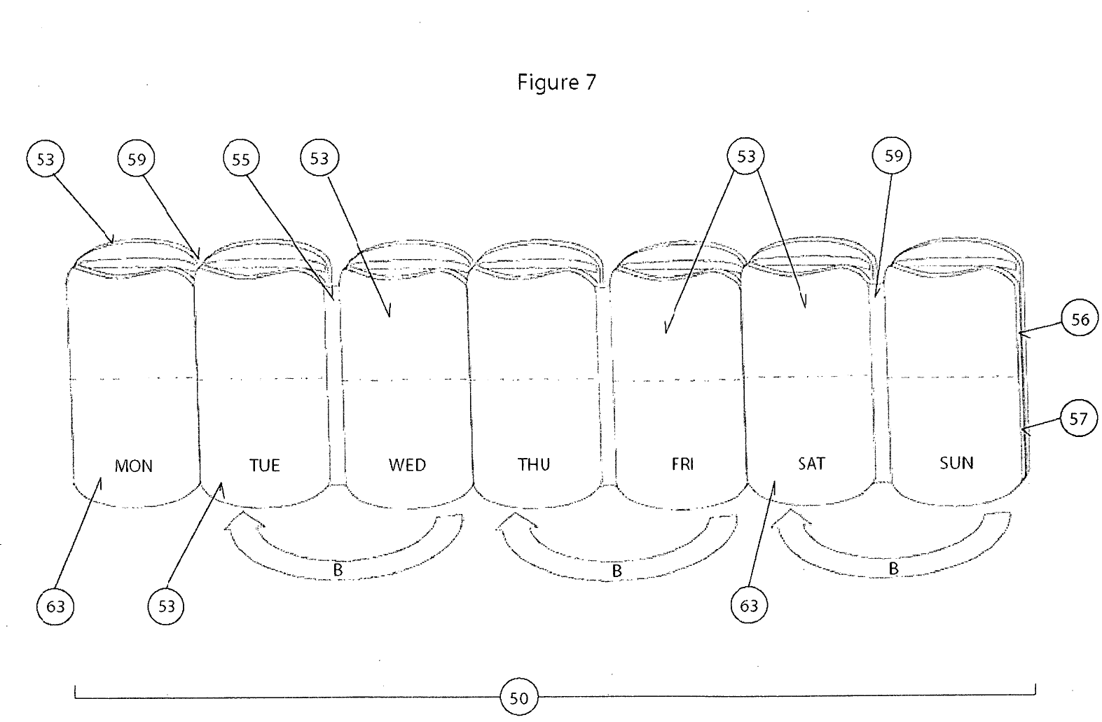

FIG. 6 shows the outer container 11 with a cutaway 61 to reveal the placement of the smaller flexible bags 43. As noted, container 11 is a personal pill carrier shaped as a generally rectangular box shaped construct. Container 11 is made of soft flexible material. Container 11 is a larger soft flexible bag with a closing means 25 such as Velcro™ or a zipper which encloses the smaller flexible bags 43. FIG. 6 can illustrate the invention with two or pair of smaller flexible bags folded as a wallet or as an accordion fold as in FIG. 7 for the smaller flexible bags 53.

FIG. 7 shows the smaller flexible bags 53 as a series 50. This embodiment shows containers for a week. Smaller flexible bags 53 with sub chambers 56 and 57 are shown opened in an accordion fashion as indicated by arrows B. Each smaller flexible bags have an indices 63.

I claim:

1) A soft flexible personal pill carrier comprising:
a larger soft flexible bag with a first closing means;
said larger soft flexible bag can receive one or more smaller soft flexible bags;
said smaller soft flexible bags each have a second closing means;
said smaller soft flexible bags can be joined in series of two or more soft flexible bags;
smaller soft flexible bags receives workpiece aliquot of pills
said smaller soft flexible bags are transported within the larger flexible bag.

2) A soft flexible personal pill carrier as in claim 1) where said smaller soft flexible bags are folded as a wallet.

3) A soft flexible personal pill carrier as in claim 1) where said smaller soft flexible bags are folded as an accordion.

4) A soft flexible personal pill carrier as in claim 1) where said smaller soft flexible bags further comprises two or more sub chambers;
said sub chambers each hahave a second closing means.
said sub chambers receive the needed workpiece aliquot of pills.

5) A soft flexible personal pill carrier as in claim 1) where said smaller soft flexible bags or their sub chambers are marked with indices.
